(19) United States
(12) Patent Application Publication
(10) Pub. No.: US 2026/0251843 A1
(43) Pub. Date: Aug. 27, 2026

(54) PHOTONIC INTEGRATED CIRCUITS WITH GUIDED-MODE EXCITATION AND COLLECTION FOR SOLID-STATE SPIN SENSORS

(71) Applicant: RTX BBN Technologies, Inc., Cambridge, MA (US)

(72) Inventors: Milica Notaros, Arlington, MA (US); Erik Eisenach, Cambridge, MA (US); Moe D. Soltani, Belmont, MA (US)

(21) Appl. No.: 19/551,336

(22) Filed: Feb. 26, 2026

Related U.S. Application Data
(60) Provisional application No. 63/763,703, filed on Feb. 26, 2025.

(51) Int. Cl. G02B 6/12

(52) U.S. Cl. CPC G02B 6/12; G02B 2006/121; G02B 2006/12109; G02B 2006/12121; G02B 2006/12138

(57) ABSTRACT

A photonic device may include a substrate, one or more substrate waveguides fabricated on the substrate, and one or more solid-state waveguides fabricated in a solid-state material including optically-addressable defects. The one or more solid-state waveguides may receive pump light from at least one of the one or more substrate waveguides. The one or more solid-state waveguides may support guiding of the pump light and photoemission from the optically-addressable defects generated in response to the pump light. The sensor may further include one or more filters coupled to at least one of the one or more substrate waveguides, where the one or more filters are configured to pass the photoemission from the optically-addressable defects and reject the pump light.

### CROSS-REFERENCE TO RELATED APPLICATION

The present application claims the benefit under 35 U.S.C. § 119(e) of U.S. Provisional Application Serial Number 63/763,703, filed February 26, 2026, entitled PHOTONIC INTEGRATED CIRCUITS WITH GUIDED-MODE EXCITATION AND COLLECTION FOR SOLID-STATE SPIN SENSORS, naming Milica Notaros, Erik Eisenach, and Moe D. Soltani as inventors, which is incorporated herein by reference in the entirety.

### TECHNICAL FIELD

The present disclosure relates generally to solid-state spin sensors and, more particularly, to guided-mode excitation and collection for solid-state spin sensors.

### BACKGROUND

Sensors that generate measurements based on solid-state spin states are a promising technology for many applications including, but not limited to, room-temperature measurements of electric fields, magnetic, strain, or temperature. However, existing technologies typically utilize bulk components that require precise alignment and often suffer from inefficient optical coupling. For example, architectures requiring free-space optical pumping are generally inefficient and may require bulky optical components that may suffer from mechanical drift. As another example, the collection of emitted signals may be challenging or inefficient due to high refractive index of substrates that contain the solid-state spin states. There is therefore a need to develop systems and methods to address the above deficiencies.

### SUMMARY

In embodiments, the techniques described herein relate to a photonic device including a substrate; one or more substrate waveguides fabricated on the substrate; one or more solid-state waveguides fabricated in a solid-state material including optically-addressable defects, where the one or more solid-state waveguides receive pump light from at least one of the one or more substrate waveguides, where the one or more solid-state waveguides support guiding of the pump light and photoemission from the optically-addressable defects generated in response to the pump light; and one or more filters coupled to at least one of the one or more substrate waveguides, where the one or more filters are configured to pass the photoemission from the optically-addressable defects and reject the pump light.

In embodiments, the techniques described herein relate to a photonic device, further including one or more detectors configured to generate detection signals associated with the photoemission passed by the one or more filters.

In embodiments, the techniques described herein relate to a photonic device, further including a controller configured to generate one or more measurements based on the detection signals.

In embodiments, the techniques described herein relate to a photonic device, where the solid-state material is disposed within a trench in the substrate, where the one or more solid-state waveguides are coupled to the one or more substrate waveguides via edge coupling.

In embodiments, the techniques described herein relate to a photonic device, where the one or more solid-state waveguides include an array of two or more solid-state waveguides.

In embodiments, the techniques described herein relate to a photonic device, where the one or more solid-state waveguides include a single solid-state waveguide.

In embodiments, the techniques described herein relate to a photonic device, where an input end and an output end of the single solid-state waveguide are on a common face of the solid-state material.

In embodiments, the techniques described herein relate to a photonic device, where the solid-state material is disposed on a top surface of the substrate and partially covers portions of the one or more substrate waveguides, where the portions of the one or more substrate waveguides covered by the solid-state material have tapered widths to provide vertical coupling with the one or more solid-state waveguides.

In embodiments, the techniques described herein relate to a photonic device, where the one or more solid-state waveguides include an array of two or more solid-state waveguides.

In embodiments, the techniques described herein relate to a photonic device, where the one or more solid-state waveguides include a single solid-state waveguide.

In embodiments, the techniques described herein relate to a photonic device, where an input end and an output end of the single solid-state waveguide are on a common face of the solid-state material.

In embodiments, the techniques described herein relate to a photonic device including a substrate; a laser source disposed on the substrate and configured to generate pump light; one or more substrate waveguides fabricated on the substrate and configured to receive the pump light; one or more solid-state waveguides fabricated in a solid-state material including optically-addressable defects, where the one or more solid-state waveguides receive the pump light from at least one of the one or more substrate waveguides, where the one or more solid-state waveguides support guiding of the pump light and photoemission from the optically-addressable defects generated in response to the pump light; one or more filters coupled to at least one of the one or more substrate waveguides, where the one or more filters are configured to pass the photoemission from the optically-addressable defects and reject the pump light; and one or more detectors configured to generate detection signals associated with the photoemission passed by the one or more filters.

In embodiments, the techniques described herein relate to a photonic device, further including a controller configured to generate one or more measurements based on the detection signals from the controller.

In embodiments, the techniques described herein relate to a photonic device, where the solid-state material is disposed within a trench in the substrate, where the one or more solid-state waveguides are coupled to the one or more substrate waveguides via edge coupling.

In embodiments, the techniques described herein relate to a photonic device, where the one or more solid-state waveguides include an array of two or more solid-state waveguides.

In embodiments, the techniques described herein relate to a photonic device, where the one or more solid-state waveguides include a single solid-state waveguide.

In embodiments, the techniques described herein relate to a photonic device, where an input end and an output end of the single solid-state waveguide are on a common face of the solid-state material.

In embodiments, the techniques described herein relate to a photonic device, where the solid-state material is disposed on a top surface of the substrate and partially covers portions of the one or more substrate waveguides, where the portions of the one or more substrate waveguides covered by the solid-state material have tapered widths to provide vertical coupling with the one or more solid-state waveguides.

In embodiments, the techniques described herein relate to a photonic device, where the one or more solid-state waveguides include an array of two or more solid-state waveguides.

In embodiments, the techniques described herein relate to a photonic device, where the one or more solid-state waveguides include a single solid-state waveguide.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1 illustrates a block diagram of a sensor, in accordance with one or more embodiments of the present disclosure.

FIG. 2A illustrates a perspective schematic view of edge coupling between a substrate waveguide and a solid-state waveguide, in accordance with one or more embodiments of the present disclosure.

FIG. 2B illustrates an intensity distribution of light in a substrate waveguide formed as a buried waveguide with a silicon nitride (SiN) core and an oxide substrate, in accordance with one or more embodiments of the present disclosure.

FIG. 2C illustrates an intensity distribution of light in a solid-state waveguide formed as a rib waveguide in diamond on an oxide substrate, in accordance with one or more embodiments of the present disclosure.

FIG. 3A illustrates a perspective view of a sensor including a solid-state material with an array of solid-state waveguides (e.g., rib waveguides) recessed within a trench of a substrate providing edge coupling with an array of substrate waveguides, in accordance with one or more embodiments of the present disclosure.

FIG. 3B illustrates a perspective view of a sensor including a solid-state material with a single solid-state waveguide recessed within a trench of a substrate providing edge coupling with substrate waveguides, in accordance with one or more embodiments of the present disclosure.

FIG. 4 illustrates a perspective schematic view of vertical coupling between a substrate waveguide and a solid-state waveguide, in accordance with one or more embodiments of the present disclosure.

FIG. 5A illustrates a perspective view of a sensor including a solid-state material with an array of solid-state waveguides on a top surface of a substrate providing vertical coupling with an array of substrate waveguides, in accordance with one or more embodiments of the present disclosure.

FIG. 5B illustrates a perspective view of a sensor including a solid-state material with a single solid-state waveguide on a top surface a substrate providing vertical coupling with substrate waveguides, in accordance with one or more embodiments of the present disclosure.

### DETAILED DESCRIPTION

Before explaining one or more embodiments of the disclosure in detail, it is to be understood the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one,” “one or more,” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of or sub-combination of two or more such features, along with any other features which may not necessarily be expressly described or inherently present in the instant disclosure.

Embodiments of the present disclosure are directed to systems and methods providing a photonic integrated circuit (PIC) platform for compact quantum sensing. In some embodiments, a sensor includes one or more substrate waveguides patterned onto a substrate (e.g., a PIC substrate) coupled to one or more solid-state waveguides in a solid-state material that includes optically-addressable defects. The solid-state waveguides may be designed to support guiding of both pump light having a wavelength designed to induce photoemission from the optically-addressable defects as well as the generated photoemission.

The systems and methods disclosed herein may enable sensing based on any type of optically-addressable defects in the solid-state waveguides such as, but not limited to, quantum sensing based on spin states of nitrogen vacancy (NV) centers in diamond. As a non-limiting illustration, a sensor as disclosed herein may be formed from one or more substrate waveguides formed from silicon nitride (SiN) or the like coupled to solid-state waveguides formed from diamond.

The substrate waveguides may be coupled with the solid-state waveguides using any coupling technique. In some embodiments, the solid-state material is located within a trench of the substrate to provide edge coupling (e.g., butt coupling) between the substrate waveguides and the solid-state waveguides. In some embodiments, the solid-state material is located on top of the substrate and partially covering the substrate waveguides. In this configuration, the covered portions of the substrate waveguides may have a tapered width that provides vertical coupling with the solid-state waveguides.

In some embodiments, the sensor includes filters coupled to at least some of the substrate waveguides to filter out the pump light such that the photoemission may be detected with a high sensitivity.

The sensor may further include one or more detectors to capture the photoemission and/or a laser source to generate the pump light. The detectors and/or the laser source may be integrated with the substrate as part of a PIC device or may be provided as separate components.

The sensor may further include a controller configured to generate one or more measurements based on detection signals from the detectors associated with the photoemission. Any type of measurement may be generated including, but not limited to, temperature, strain, electric field, or magnetic field.

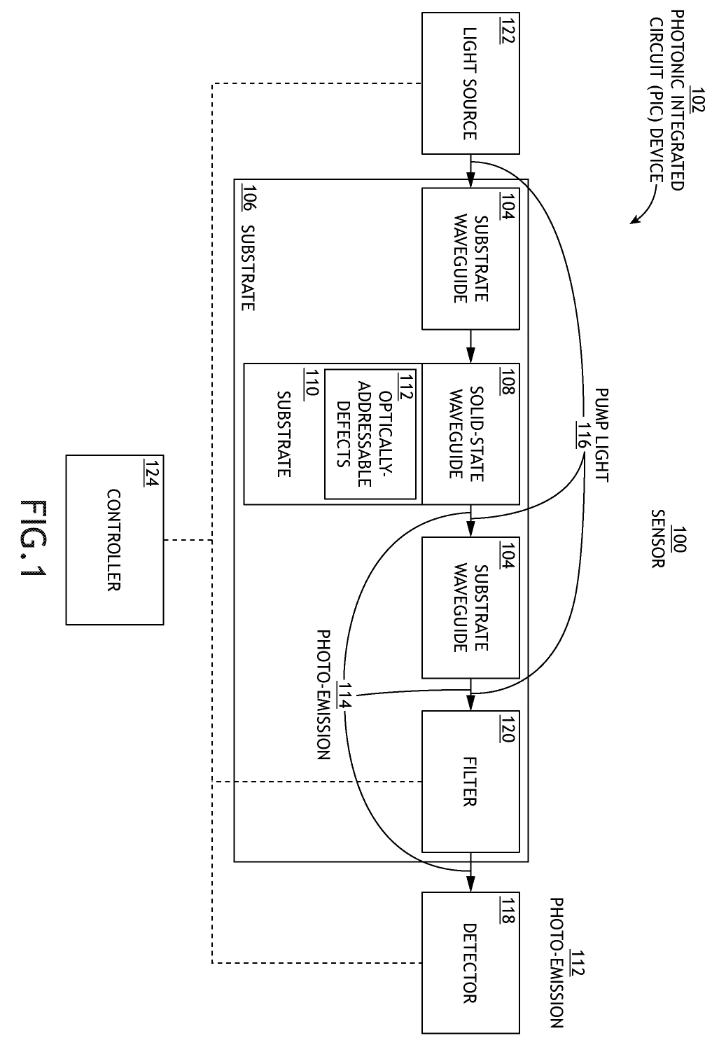

Referring now to FIGS. 1-5B, systems and methods providing quantum sensing in a PIC platform are described in greater detail, in accordance with one or more embodiments of the present disclosure.

FIG. 1 illustrates a block diagram of a sensor 100, in accordance with one or more embodiments of the present disclosure.

In some embodiments, the sensor 100 includes a PIC device 102 with one or more substrate waveguides 104 disposed on a substrate 106. The substrate 106 may be formed from any material including, but not limited to, an oxide (e.g., silicon dioxide, or the like) or a semiconductor (e.g., silicon, or the like). The substrate waveguides 104 may be formed from any material suitable for guiding light when disposed in or around the substrate 106 such as, but not limited to, silicon nitride (SiN). The substrate waveguides 104 may further have any shape or configuration such as, but not limited to, buried waveguides, strip waveguides, or rib waveguides.

In some embodiments, the sensor 100 includes one or more solid-state waveguides 108 formed in a solid-state material 110, where the solid-state material 110 includes optically-addressable defects 112 that generate photoemission 114 in response to selected wavelengths of pump light 116.

The solid-state waveguides 108 may include any material (e.g., solid-state material) having any type of optically-addressable defects 112 suitable for sensing. In some embodiments, the solid-state material 110 is diamond and the optically-addressable defects 112 are NV centers. It is recognized herein that NV centers in diamond are a promising platform for room-temperature quantum metrology for a variety of measurements including, but not limited to, temperature, strain, electric field, or magnetic fields. For instance, spin states and transitions of such NV centers that are sensitive to such measured parameters may be manipulated and read out using optical techniques. As an illustration, the NV centers may be optically excited by the pump light 116 propagating in the one or more solid-state waveguides 108 and may emit spin-dependent photoemission 114 (e.g., fluorescence) upon relaxation, which may also propagate in the solid-state waveguides 108 and may be detected as the basis of a measurement.

The solid-state waveguides 108 may further be designed to guide (e.g., propagate with losses below a selected threshold) wavelengths associated with both the pump light 116 and the photoemission 114. The solid-state waveguides 108 may have any geometry such as, but not limited to, a rib waveguide geometry. For example, properties such as, but not limited to, cross-sectional dimensions may be designed to guide wavelengths associated with both the pump light 116 and the photoemission 114. In this configuration, pump light 116 propagating through the solid-state waveguides 108 may excite the optically-addressable defects 112 in the solid-state waveguides 108. Further, photoemission 114 generated by the optically-addressable defects 112 in response to the pump light 116 may propagate (potentially bidirectionally) through the solid-state waveguides 108 and couple back into at least some of the substrate waveguides 104 for detection. For example, FIG. 1 conceptually depicts substrate waveguides 104 on both sides of a solid-state material 110, but this is merely illustrative and not limiting on the scope of the present disclosure. Substrate waveguides 104 may be placed on any side or combination of sides of the solid-state material 110 for coupling of light into or out of the solid-state waveguides 108.

In some embodiments, the sensor 100 includes one or more detectors 118 coupled to the one or more substrate waveguides 104 to generate detection signals based on the photoemission 114. A detector 118 may include any optical sensing device suitable for generating detection signals based on incident photoemission 114 such as, but not limited to, one or more photodiodes. Further, the one or more detectors 118 may be integrated onto the substrate 106 as part of the PIC device 102 (e.g., as depicted in FIG. 1) or may be provided as external components.

In some embodiments, the sensor 100 includes one or more filters 120 coupled to the one or more substrate waveguides 104 between the solid-state material 110 and the detectors 118. In this configuration, the filters 120 may filter out the pump light 116 and thus prevent or reduce the amount of pump light 116 reaching the one or more detectors 118. Put another way, the filters 120 may pass the photoemission 114 and reject the pump light 116. The sensor 100 may include any type of filters 120 known in the art suitable for filtering out at least a portion of the pump light 116. For example, the filter 120 may include an evanescent waveguide coupler that is wavelength-selective, an unbalanced Mach-Zender interferometer, or a resonator-based filter. Further, the sensor 100 may include any number of cascaded or multi-stage filters 120. Further, filters 120 may be integrated with the substrate 106 as part of the PIC device 102 (e.g., as depicted in FIG. 1) or provided as separate components.

In some embodiments, the sensor 100 includes a light source 122 to generate the pump light 116 having spectral content (e.g., one or more wavelengths) suitable for exciting the optically-addressable defects 112. For example, the light source 122 may include one or more wavelengths in an excitation band of the optically-addressable defects 112. As an illustration in the case of NV centers in a diamond solid-state material 110, the light source 122 may generate pump light 116 having wavelengths in a spectral range of 510-580 nanometers (nm). In some embodiments, the light source 122 is a laser source. Further, the light source 122 may be integrated onto the substrate 106 as part of the PIC device 102 (e.g., as depicted in FIG. 1) or may be provided as an external component.

In some embodiments, the sensor 100 includes a controller 124. The controller 124 may include one or more processors suitable for executing program instructions stored on a memory device such as, but not limited to, a non-transitory memory device. For instance, the controller 124 may include a digital signal processor (DSP), a field-programmable gate array (FPGA) device, an application-specific integrated circuit (ASIC), a central processing unit (CPU), or a graphical processing unit (GPU).

The controller 124 may be coupled with any components of the sensor 100 such as, but not limited to, the light source 122, the detectors 118, or the filters 120. In this way, the controller 124 may receive data from and/or control (e.g., by generating control signals) any connected components. For example, the controller 124 may receive detection signals from one or more detectors 118 and generate one or more measurements based on the detection signals. As another example, the controller 124 may tune the filters 120 (e.g., by controlling phase shifters therein) to match a wavelength of the pump light 116.

In some embodiments, the controller 124 generates additional control signals to control other components within the sensor 100 or components that may interact with the sensor 100. For example, controller 124 may generate control signals that control microwave excitation used for sensing. In this way, the controller 124 may coordinate in time the application of pump light 116 and microwave irradiation to achieve a certain sensing/measurement protocol. The microwave components (e.g. antenna and waveguides) could be separate from the PIC device 102 or combined with the PIC device.

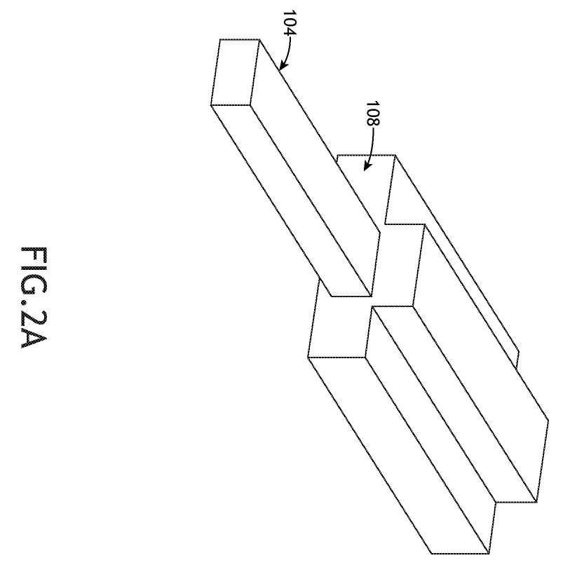

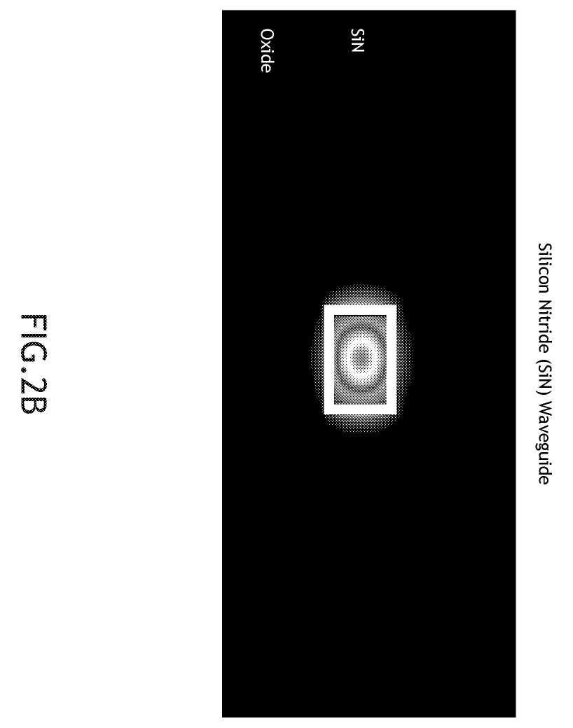

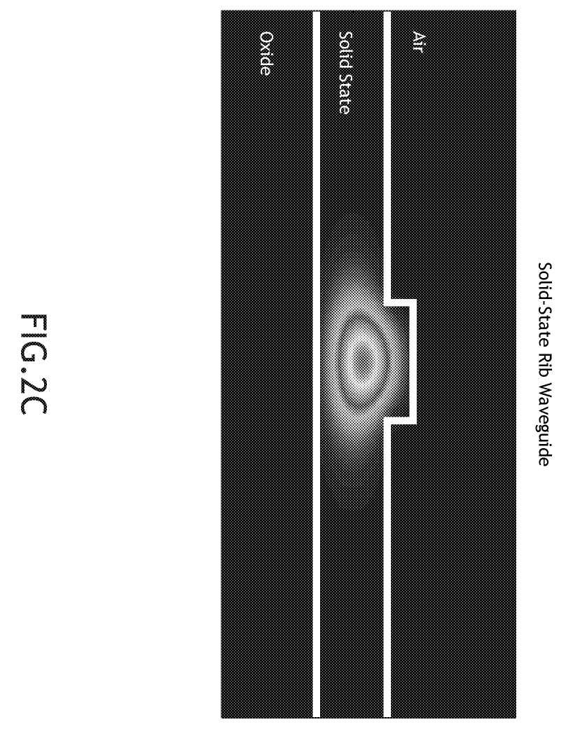

Referring now to FIGS. 2A-5B, various nonlimiting geometries for coupling substrate waveguides 104 and solid-state waveguides 108 are described.

In some embodiments, substrate waveguides 104 and solid-state waveguides 108 are edge coupled (e.g., butt-coupled). FIG. 2A illustrates a perspective schematic view of edge coupling between a substrate waveguide 104 and a solid-state waveguide 108, in accordance with one or more embodiments of the present disclosure. For the purposes of clarity, the substrate 106 surrounding portions of the substrate waveguide 104 are omitted. FIG. 2B illustrates an intensity distribution of light in a substrate waveguide 104 formed as a buried waveguide with a SiN core and an oxide substrate, in accordance with one or more embodiments of the present disclosure. FIG. 2C illustrates an intensity distribution of light in a solid-state waveguide 108 formed as a rib waveguide in diamond on an oxide substrate, in accordance with one or more embodiments of the present disclosure. FIGS. 2A-2C illustrate excellent mode confinement in both the substrate waveguide 104 and the solid-state waveguide 108.

Edge coupling may be provided by any suitable design of the sensor 100. In some embodiments, the solid-state material 110 is recessed into a trench or hole of the substrate 106, which may align the one or more substrate waveguides 104 with the one or more solid-state waveguides 108.

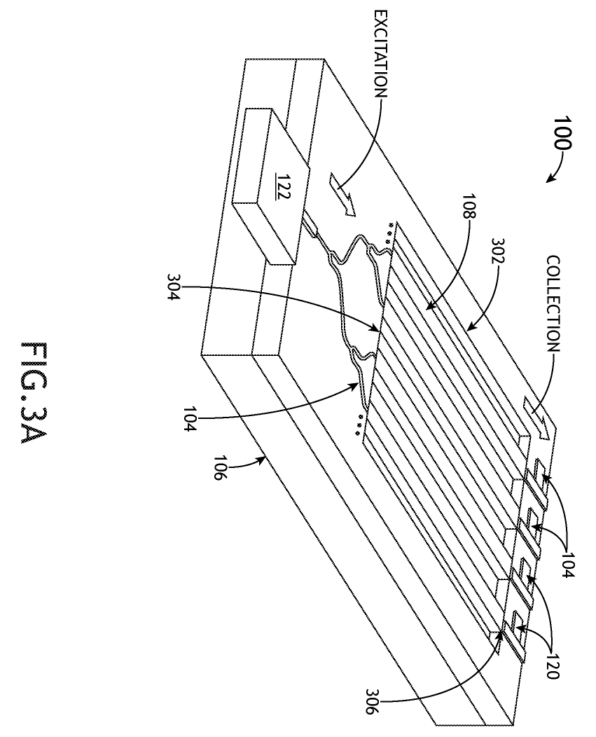

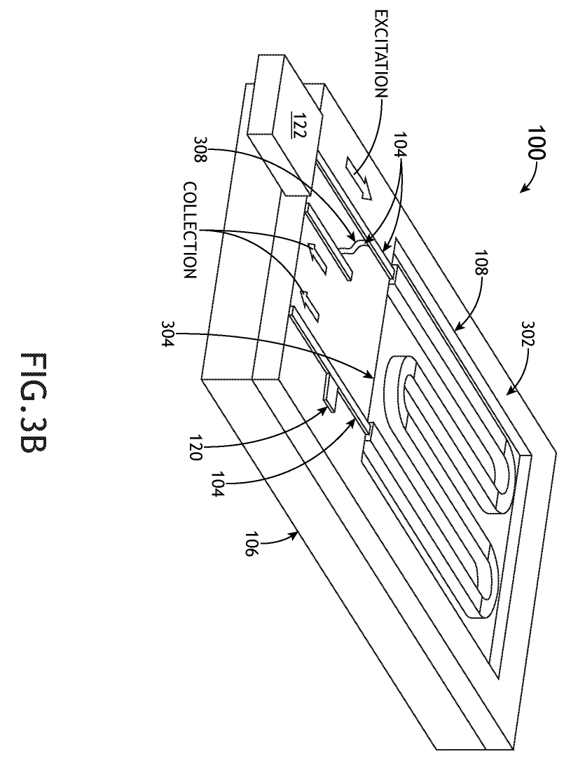

FIG. 3A illustrates a perspective view of a sensor 100 including a solid-state material 110 with an array of solid-state waveguides 108 (e.g., rib waveguides) recessed within a trench 302 of a substrate 106 providing edge coupling with an array of substrate waveguides 104, in accordance with one or more embodiments of the present disclosure. In particular, FIG. 3A depicts a configuration in which pump light 116 is coupled into a branching array of substrate waveguides 104 that couple the pump light 116 into the array of solid-state waveguides 108 at a first face 304 of the solid-state material 110. Further, FIG. 3A depicts a configuration including additional substrate waveguides 104 and coupled filters 120 on an opposing second face 306 of the solid-state material 110 to collect the photoemission 114. The trench 302 may have any depth suitable for aligning the substrate waveguides 104 and the substrate 106.

FIG. 3B illustrates a perspective view of a sensor 100 including a solid-state material 110 with a single solid-state waveguide 108 recessed within a trench 302 of a substrate 106 providing edge coupling with substrate waveguides 104, in accordance with one or more embodiments of the present disclosure. In FIG. 3B, the sensor 100 includes a single solid-state waveguide 108, which provides a meandering path across a surface of the solid-state material 110 (e.g., to promote interaction of the pump light 116 with the optically-addressable defects 112). Accordingly, the sensor 100 includes substrate waveguides 104 coupled to both ends of the solid-state waveguide 108.

Further, FIG. 3B depicts a configuration in which both ends of the solid-state waveguide 108 (e.g., an input end and an output end) are oriented along a common face 304 of the solid-state material 110. This configuration may facilitate fabrication or coupling of components such as, but not limited to, the light source 122, the filters 120, and/or the one or more detectors 118 in a common region of the PIC device 102.

More generally, any solid-state waveguides 108 may have any path. For example, a solid-state waveguide 108 may loop back one time, be in a spiral configuration, or any have any suitable path.

Referring now generally to FIGS. 3A and 3B, it is contemplated herein that photoemission 114 may propagate bidirectionally through the one or more solid-state waveguides 108 and may thus be collected from any end of any of the solid-state waveguides 108. For example, FIG. 3A depicts collection of photoemission 114 that propagates along a common direction as the pump light 116. As another example, FIG. 3B depicts collection of photoemission 114 from both the direction of propagation of the pump light 116 as well as the opposing direction. In particular, FIG. 3B illustrates how the substrate waveguides 104 may include one or more tap waveguides 308 to split off photoemission 114 propagating in an opposing direction as the pump light 116. Further, as depicted in FIG. 3B, a filter 120 may not always be necessary when capturing counterpropagating photoemission 114 collected via a tap waveguide 308.

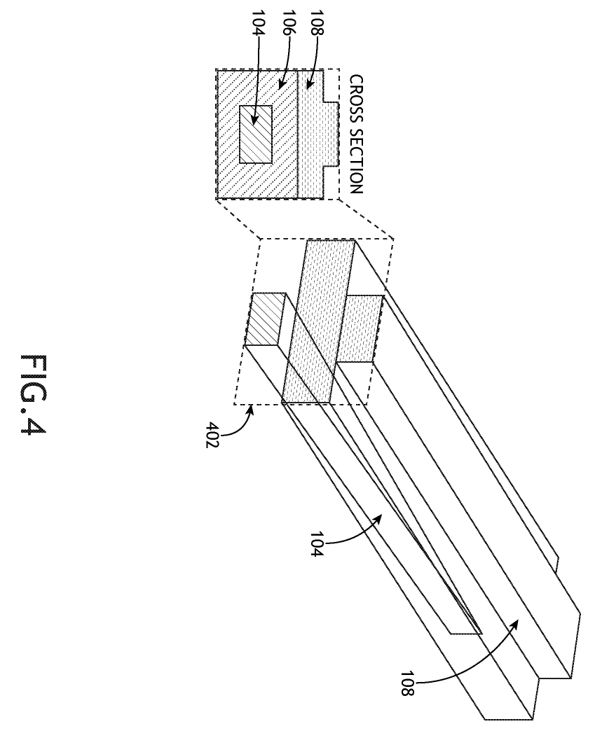

In some embodiments, substrate waveguides 104 and solid-state waveguides 108 are coupled through vertical transitions based on adiabatically changing shapes of the substrate waveguides 104 and/or the solid-state waveguides 108 within an interaction region. FIG. 4 illustrates a perspective schematic view of vertical coupling between a substrate waveguide 104 and a solid-state waveguide 108, in accordance with one or more embodiments of the present disclosure. For the purposes of clarity, the substrate 106 surrounding portions of the substrate waveguide 104 are omitted.

In FIG. 4, the solid-state material 110 with a solid-state waveguide 108 is fabricated above a substrate waveguide 104 such that the solid-state waveguide 108 covers a portion of the substrate waveguide 104. Further, one or more dimensions of the substrate waveguide 104 (here, the width) may adiabatically decrease in a direction away from a coupling plane 402. In this way, light propagating in the substrate waveguide 104 may gradually undergo a vertical transition to the solid-state waveguide 108 as the width decreases. Similarly, light propagating in the solid-state waveguide 108 in an opposing direction may similarly undergo a vertical transition to the substrate waveguide 104.

Vertical coupling may be provided by any suitable design of the sensor 100. In some embodiments, the solid-state material 110 is located on a surface of substrate 106 such that the solid-state material 110 covers portions of the substrate waveguides 104, which may align the one or more substrate waveguides 104 with the one or more solid-state waveguides 108.

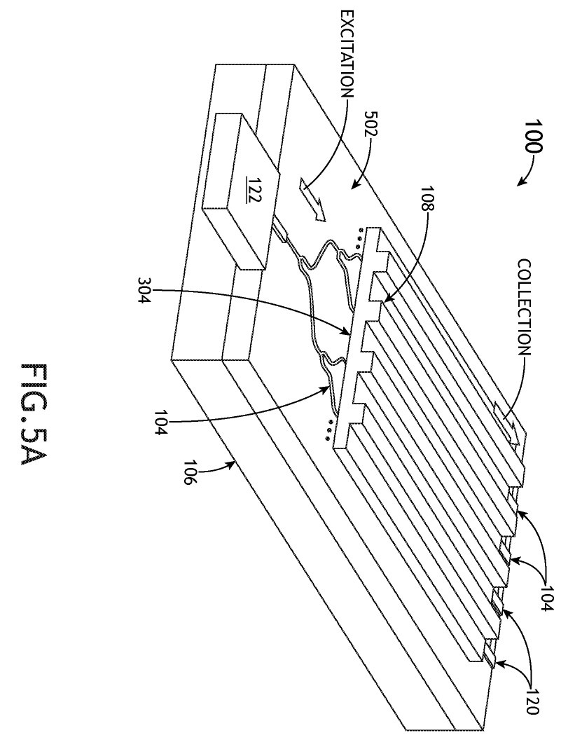

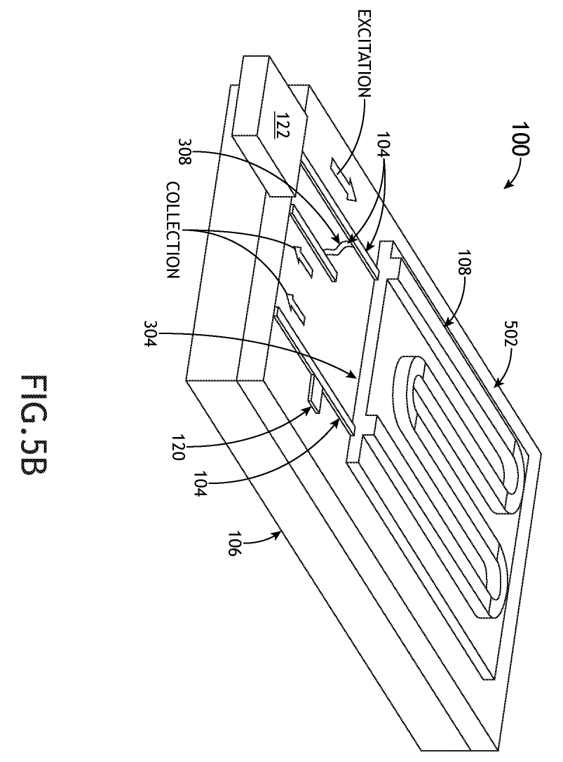

FIG. 5A illustrates a perspective view of a sensor 100 including a solid-state material 110 with an array of solid-state waveguides 108 on a top surface 502 of a substrate 106 providing vertical coupling with an array of substrate waveguides 104, in accordance with one or more embodiments of the present disclosure. FIG. 5A is substantially similar to FIG. 3A except for the coupling mechanism. FIG. 5B illustrates a perspective view of a sensor 100 including a solid-state material 110 with a single solid-state waveguide 108 on a top surface 502 a substrate 106 providing vertical coupling with substrate waveguides 104, in accordance with one or more embodiments of the present disclosure. FIG. 5B is substantially similar to FIG. 3B except for the coupling mechanism.

Although the disclosure has been described with reference to the embodiments illustrated in the attached drawing figures, equivalents may be employed and substitutions made herein without departing from the scope of the claims. Components illustrated and described herein are merely examples of a system/device and components that may be used to implement embodiments of the disclosure and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A photonic device comprising:
a substrate;
one or more substrate waveguides fabricated on the substrate;
one or more solid-state waveguides fabricated in a solid-state material including optically-addressable defects, wherein the one or more solid-state waveguides receive pump light from at least one of the one or more substrate waveguides, wherein the one or more solid-state waveguides support guiding of the pump light and photoemission from the optically-addressable defects generated in response to the pump light; and
one or more filters coupled to at least one of the one or more substrate waveguides, wherein the one or more filters are configured to pass the photoemission from the optically-addressable defects and reject the pump light.

2. The photonic device of claim 1, further comprising one or more detectors configured to generate detection signals associated with the photoemission passed by the one or more filters.

3. The photonic device of claim 2, further comprising a controller configured to generate one or more measurements based on the detection signals.

4. The photonic device of claim 1, wherein the solid-state material is disposed within a trench in the substrate, wherein the one or more solid-state waveguides are coupled to the one or more substrate waveguides via edge coupling.

5. The photonic device of claim 4, wherein the one or more solid-state waveguides comprise an array of two or more solid-state waveguides.

6. The photonic device of claim 4, wherein the one or more solid-state waveguides comprise a single solid-state waveguide.

7. The photonic device of claim 6, wherein an input end and an output end of the single solid-state waveguide are on a common face of the solid-state material.

8. The photonic device of claim 1, wherein the solid-state material is disposed on a top surface of the substrate and partially covers portions of the one or more substrate waveguides, wherein the portions of the one or more substrate waveguides covered by the solid-state material have tapered widths to provide vertical coupling with the one or more solid-state waveguides.

9. The photonic device of claim 8, wherein the one or more solid-state waveguides comprise an array of two or more solid-state waveguides.

10. The photonic device of claim 9, wherein the one or more solid-state waveguides comprise a single solid-state waveguide.

11. The photonic device of claim 10, wherein an input end and an output end of the single solid-state waveguide are on a common face of the solid-state material.

12. A photonic device comprising:
a substrate;
a laser source disposed on the substrate and configured to generate pump light;
one or more substrate waveguides fabricated on the substrate and configured to receive the pump light;
one or more solid-state waveguides fabricated in a solid-state material including optically-addressable defects, wherein the one or more solid-state waveguides receive the pump light from at least one of the one or more substrate waveguides, wherein the one or more solid-state waveguides support guiding of the pump light and photoemission from the optically-addressable defects generated in response to the pump light;
one or more filters coupled to at least one of the one or more substrate waveguides, wherein the one or more filters are configured to pass the photoemission from the optically-addressable defects and reject the pump light; and
one or more detectors configured to generate detection signals associated with the photoemission passed by the one or more filters.

13. The photonic device of claim 12, further comprising a controller configured to generate one or more measurements based on the detection signals from the controller.

14. The photonic device of claim 12, wherein the solid-state material is disposed within a trench in the substrate, wherein the one or more solid-state waveguides are coupled to the one or more substrate waveguides via edge coupling.

15. The photonic device of claim 14, wherein the one or more solid-state waveguides comprise an array of two or more solid-state waveguides.

16. The photonic device of claim 14, wherein the one or more solid-state waveguides comprise a single solid-state waveguide.

17. The photonic device of claim 16, wherein an input end and an output end of the single solid-state waveguide are on a common face of the solid-state material.

18. The photonic device of claim 12, wherein the solid-state material is disposed on a top surface of the substrate and partially covers portions of the one or more substrate waveguides, wherein the portions of the one or more substrate waveguides covered by the solid-state material have tapered widths to provide vertical coupling with the one or more solid-state waveguides.

19. The photonic device of claim 18, wherein the one or more solid-state waveguides comprise an array of two or more solid-state waveguides.

20. The photonic device of claim 19, wherein the one or more solid-state waveguides comprise a single solid-state waveguide.
